(19) United States
(12) Patent Application Publication
(10) Pub. No.: US 2020/0247175 A1
(43) Pub. Date: Aug. 6, 2020

(54) BRISTLE BRUSH- and PAINT ROLLER-COVER

(71) Applicants: Victor Pirooz Darai, Naples, FL (US); Ramin Gorji, Naples, FL (US)

(72) Inventors: Victor Pirooz Darai, Naples, FL (US); Ramin Gorji, Naples, FL (US)

(21) Appl. No.: 16/267,432

(22) Filed: Feb. 5, 2019

(51) Int. Cl. B44D 3/12

(52) U.S. Cl. CPC B44D 3/125; A46B 17/04; B44D 3/123

(57) ABSTRACT

The present invention relates to a sealable airtight cover that prevents any painting tools such as bristle brushes, paint rollers or any other painting tools, for example, airbrush guns, from drying.

The cover is used when one desires to retentively enclose a wet bristle brush or paint roller and preserve the same ready for use later on.

The cover is to be in sealed position by any means over a wet bristle brush or paint roller cover to maintain the material in a fresh condition and prevent it from drying.

The cover is a quick closable airtight storing device made of a waterproof and solvent resistant soft material comprising a V-shape bag providing an enclosing pouch for said a bristle brush or a paint roller.

The cover is to be attached tightly from one end to the handle of a painting tool such as a bristle brush or a paint roller and functions like a mitt during a painting job. To prevent the wet stained bristle or the roller cover from drying, the cover's other end is pulled up and over the brush and sealed by a sealing mechanism.

### CROSS-REFERENCE TO RELATED APPLICATIONS

A container for temporarily holding and storing a wet paintbrush are known in the prior art. In U.S. Ser. No. 08/312,058 will maintain the paintbrush in a useful condition for a limited period of time up to several days. The container has the shape of a hollow, substantially rectangular box and therefore, it is not suitable for roller brushes or painting tools. Furthermore, the prior invention is to provide a hard cover which is not as flexible as a soft one.

Containers for temporarily storing wet paintbrushes are known in the prior art. In U.S. Pat. No. 3,690,448 a closable plastic bag is provided. The entire paintbrush is inserted into the plastic bag, and the plastic bag is sealed. The disadvantage of this product is that the entire brush comes in contact with the wet paint and gets dirty.

Because of the messy problem of inserting the entire paint stained brush into the plastic bag, the bristles are first wrapped in flexible plastic that is held on the bristles by a rubber band.

A box-like container is disclosed in U.S. Pat. No. 4,746,042 that is worn on a belt of a painter and can be used to hold a wet paintbrush for short periods of time. The box-like container is open at its upper end so that a paintbrush can be readily inserted into and removed from the container by the painter. Because of the open end, however, the brush can only be stored for relatively short periods of time, such as a few hours at the most. The brush cannot be stored overnight for use the next day. This invention is to provide a hard protective cover to fit and is not flexible for Roller brushes and other painting tools.

In U.S. Pat. No. 4,771,501 there is disclosed a paintbrush holder that is capable of holding a solvent. The holder has a removable top, and the paintbrush is placed entirely within the container, with the bristles submerged in the solvent. The top can be closed so as to encapsulate the paintbrush entirely within the container, and the paintbrush can be stored for extended periods of time. The brush cannot be stored for several days. This invention is to provide a hard protective cover to fit and is not flexible for Roller brushes and other painting tools.

### BACKGROUND OF THE INVENTION

### 1. Technical Description

The present invention relates generally to a cover that prevent a, wet bristle, paint roller cover, and airbrush gun nozzle from drying when not used.

This invention is directed to, paint rollers, bristle brushes, painting tools, or any airbrush guns, with the cover attached to its handle wherein the cover can swing to the seal position over the stained bristle or roller brush to maintain them in a reusable condition for a longer period of time.

### 2. Field of the Invention

A flexible cover for a bristle brush or paint roller cover is designed for temporary storage of wet bristle brushes, wet paint rollers, or any wet painting device's head, in order to prevent them from drying after use and keep them fresh for hours.

In this, the cover is a soft bag with one end of it clamped to the handle of a bristle brush or a paint roller.

### BRIEF SUMMARY OF THE INVENTION

Accordingly, the object of the present invention is that during a painting job project store the wet stained brushes, paint rollers or other painting tools in an airtight bag to prevent them from drying.

Another object of this invention is to provide a cover that is attached to the handle of the painting tool, and fold and sealed around the bristle of a brush or a paint roller cover.

In view of the foregoing disadvantages inherent in the known types of disposable plastic bags now present and container for temporarily storing in the prior art, the present invention provides a new disposable flexible bags for temporarily storing wet stained bristle brushes and paint rollers. Bristle brushes, paint rollers, and airbrushes are relatively expensive. Replacing the painting tools is a costly business for the Professional Contractors and amateur painters alike.

Proper care of a painting tool can increase its lifetime and multiple reuse of it, hence reducing overall costs.

Painting tools characteristic is to apply liquid paint. Removing paint residue from a painting tool in order to clean it can be an annoying and time consuming task. Furthermore, it is possible that after washing and cleaning a brush it still holds water or color solvent that may cause problem when reused. Therefore, after use, keeping a bristle brush or paint roller inside a sealed container prevents it from drying and at the same time minimizes the impact of unwanted cleaning residues.

The latest technology discloses painting tools' cover made primarily of paper products or hard cover. The disadvantage of paper covers is that they can be moist with fresh paint, water, or a solvent which in turn can cause the cover's quick deterioration. The disadvantage of hard covers is that they are designed for a specific brush size and shape and are not all around, hence costly for the consumers.

On the basis of the above facts, it is therefore desired to use an inexpensive functional product with a good quality that securely covers the bristle or roller cover, is all around, and fits all shapes of available painting tools.

### BRIEF DESCRIPTION OF THE DRAWINGS

Preferred embodiments of the present invention representing the best mode presently contemplated of carrying out the invention are illustrated in the following, be described six embodiments of the invention with reference to the drawings.

FIG. 1 illustrates a front perspective view of a bristle brush and a paint roller storage bag.

FIG. 2 illustrates a front perspective view of a bristle brush and a paint roller storage bag with a paint roller.

FIG. 3 illustrates a front perspective view of a bristle brush and a paint roller storage bag with bristle brush.

FIG. 4 illustrates a right side perspective view of a bristle brush and a paint roller storage bag with a paint roller in the storage bag.

FIG. 5 illustrates a top perspective view of a bristle brush and a paint roller storage bag with a bristle brush in the storage bag.

FIG. 6 illustrates a top perspective view of a bristle brush and a paint roller storage bag with paint roller. The storage bag covers the painter's hand or arm from paint drops.

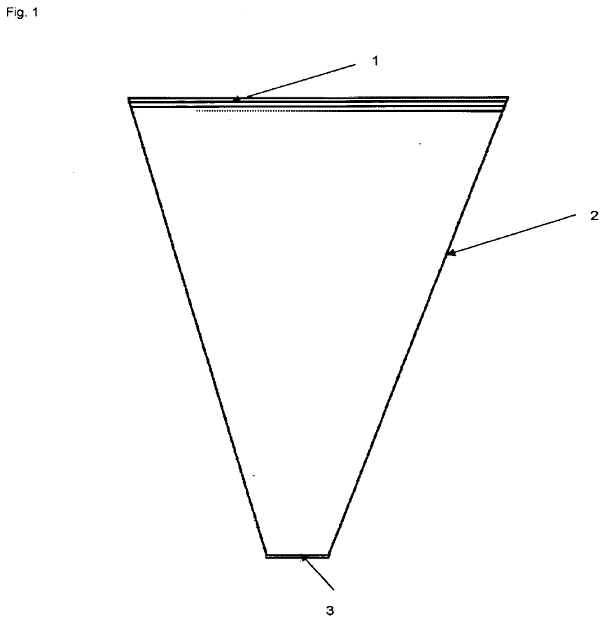

In FIG. 1, the storage bag (2) has a wide upper end (1) and a [thin] narrow rubber base (3).

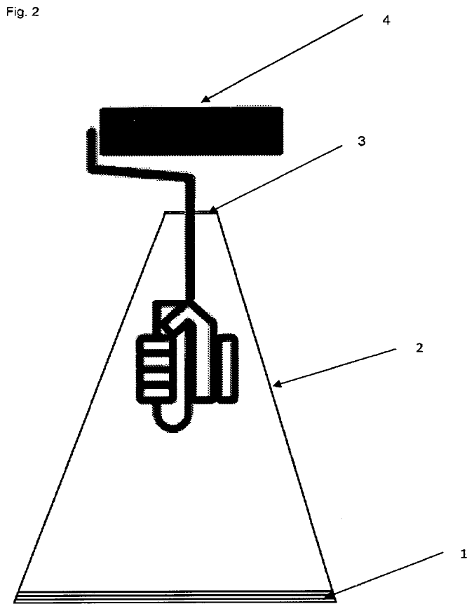

In FIG. 2-5, the storage bag (2) has a wide upper (1) and a [thin] narrow rubber base (3). The rubber base (3) is clamped to the handle of the bristle brush, paint roller.

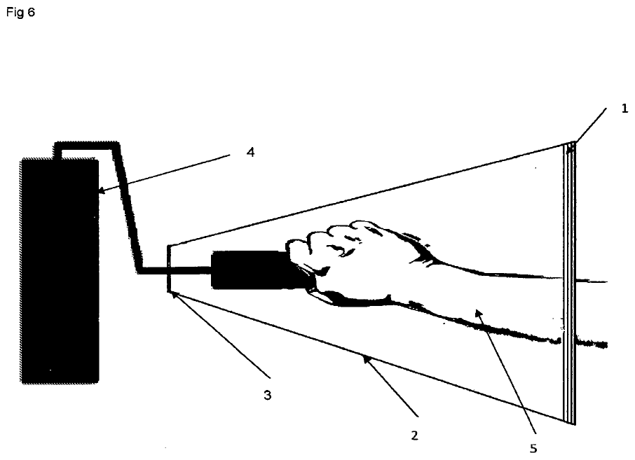

In FIG. 6, the storage bag (2), the rubber base (3) is clamped to the handle of the bristle brush, paint roller. During a painting job the storage bag is in a lowered position and it covers the hand of the painter from paint drops.

### DETAILED DESCRIPTION OF THE INVENTION

Referring now to the drawings, in FIG. 1, the bristle brushes and paint rollers V-shaped storage bags (2) is attached from one end to the handle of a bristle brush then to cover the bristle, the soft cover's other end is pulled over it and sealed by a sealing mechanism (1).

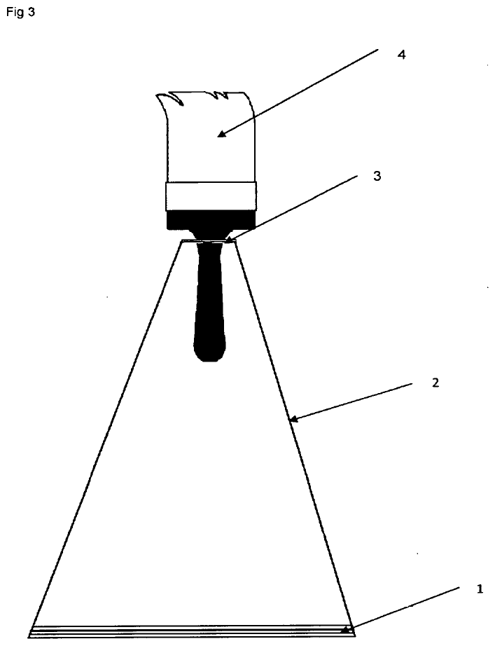

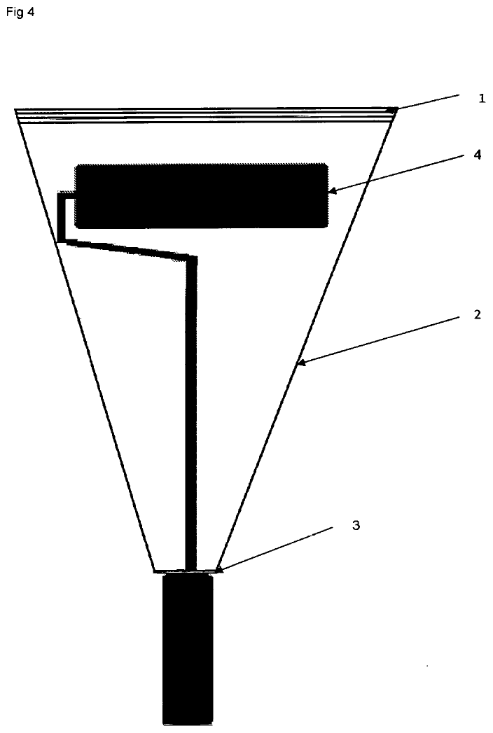

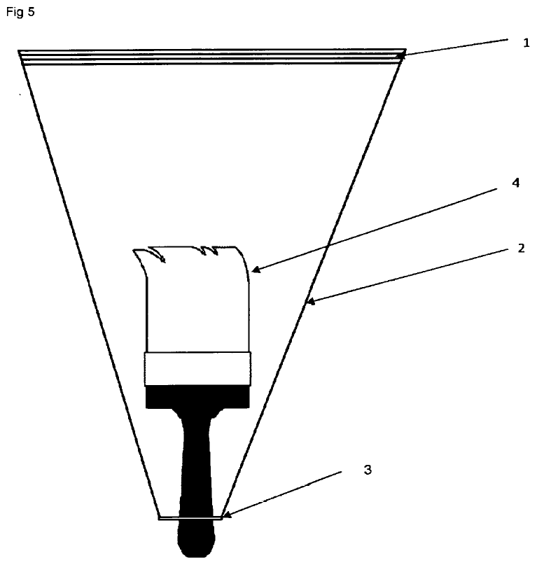

The elasticity of the rubber (3) end of the storage bag encompasses the handle of any painting tools easily FIG. 2 and FIG. 3. The other end of the storage bag has a re-sealing mechanism (1) which is to be sealed after covering the bristle or roller cover FIG. 4 and FIG. 5.

The sealed bag prevents the wet stained bristle or paint roller cover from drying and keeps the bristle or roller cover in good reusable condition.

The storage bag as described in this patent has a wide upper end (1) and a slim base made of a relatively tight elastic band such as a rubber band (3). The elastic band base will clasp on to the handle of a bristle brush or a paint roller handle. During a painting job, the protection bag (2) functions as a mitt and protects painter's hand (5) from paint drips and splashes FIG. 6.

The bristle brush and paint roller storage bag is to be made of materials such as, polyvinyl chloride, polyethylene, polypropylene, polycarbonate, which are resistant to water based or oil based paints. Poly (vinyl chloride) is a preferred material choice for this product.

The storage bag is lightweight, simple to use, and inexpensive to manufacture. The storage bag may be of plastic, and may be made by plastic bag extrusion. Appropriate methods are known to those skilled in the art, and other materials.

While the present invention has been described herein with reference to the specific embodiments thereof, it is to be understood by those skilled in this art that various changes may be made and equivalents may be substituted without departing from the true spirit and scope of the present invention. In addition, many modifications may be made to adapt to a particular situation, material or article within the spirit and scope of this invention, without departing from its essential teachings.

1. The bristle brush's and paint roller' storage bag
characterized,
that is a storage bag (2) with a sealable wide upper (1) and, preferably, a narrow base (3), where the base (3) is clamped to the handle of the bristle brush, or the paint roller.

2. A Storage bag as in claim 1,
wherein said the storage bag is made of any material that is waterproof and/or oil solvent resistant, for example, any kind of plastic or silicone material.

3. A Storage bag as in claim 1,
wherein said a wide re-sealable upper end.

4. A Storage bag as in claim 3,
where in said the upper end is to be closed with any type of zippers, tapes, rubber bands, hook and loop, or threads.

5. A storage bag as in claim 1,
wherein said the storage bag clamps to the painting tool's handle with its lower narrow end by means of any kind of elastic material such as a rubber band.

6. A Storage bag as in claim 1,
wherein said the storage bag clamps to the painting tool's handle with its lower narrow end by means of a hook and loop fastener.

7. A Storage bag as in claim 1,
wherein said the storage bag clamps to the painting tool's handle with its lower narrow end by means of a thread.

8. A Storage bag as in claim 1,
wherein said the storage bag is a V-Shaped bag with a wide re-sealable upper end and a narrow lower end.

9. A Storage bag as in claim 1,
wherein said the storage bag is a V-Shaped bag with a wide re-sealable upper end and a narrow lower end may be preferably embedded with any bristle Brush.
